(19) United States
(12) Patent Application Publication
(10) Pub. No.: US 2007/0215468 A1
(43) Pub. Date: Sep. 20, 2007

(54) Gas sensor element and method of manufacturing gas sensor element

(75) Inventors: Toshikazu Hirose, Anjo-shi (JP); Susumu Naito, Kariya-shi (JP); Makoto Nakae, Nagoya (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/703,092

(22) Filed: Feb. 7, 2007

(30) Foreign Application Priority Data
Mar. 14, 2006 (JP) 2006-069601

(51) Int. Cl. G01N 27/26

(52) U.S. Cl. 204/424

(57) ABSTRACT

A gas sensor element and related manufacturing method are disclosed comprising the steps of preparing a gas sensor element body, including a solid electrolyte body having both sides formed with a measuring-gas-side electrode and a reference-gas-side electrode, respectively, and a diffusion resistance layer formed the solid electrolyte body so as to surround the measuring-gas-side electrode, coating a trap layer forming slurry, having an aluminum ion content equal to or less than 1.2 wt %, on at least an outer sidewall of the difflusion resistance layer of the gas sensor element body, and baking a coated layer of the trap layer forming slurry to form a trap layer on the outer sidewall of the diffusion resistance layer.

### CROSS REFERENCE TO RELATED APPLICATIONS

This application is based on Japanese Patent Application No. 2006-69601, filed on Mar. 14, 2006, the content of which is hereby incorporated by reference.

### BACKGROUND OF THE INVENTION

1. Field of the Invention

The present invention relates to gas sensors for detecting a concentration of specified gas in measuring gases and, more particularly, to a gas sensor element of a gas sensor for use in controlling combustion of an air fuel mixture in an internal combustion engine such as an automotive engine and a method of manufacturing the gas sensor element.

2. Description of the Related Art

In modern internal combustion engines, for the purpose of performing combustion control in an automotive engine, attempts have heretofore been made for gas sensors to be installed on exhaust systems of internal combustion engines of motor vehicles for detecting an oxygen concentration in exhaust gases.

The gas sensors usually employ gas sensor elements. Each of these gas sensor elements includes a solid electrolyte body, having oxygen ion conductivity, and a detecting section, composed of a measuring-gas-side electrode formed on one side of the solid electrolyte body whose other side is formed with a reference-gas-side electrode, for detecting a specified gas in measuring gases.

However, measuring gases may contain toxic compounds such as, for instance, Pb, P, S or the like, which are harmful to electrode materials. These toxic compounds are brought into contact with the measuring-gas-side electrode, causing an issue to arise with the occurrence of corrosions caused in the electrode with degraded detecting capability.

To address such an issue, an attempt has heretofore been made to provide a gas sensor element including a detecting section whose outer circumferential periphery has a porous trap layer to prevent toxic compounds from entering and approaching to the measuring-gas-side electrode. Such a trap layer is disclosed in, for instance, Japanese Patent Unexamined Application Publication No. 6-174683.

However, the gas sensor element having the trap layer is subjected to high temperatures of exhaust gases expelled from the engine, causing increased fluctuation of a sensor output to occur during usage of the gas sensor.

It is considered that such sensor output fluctuation is caused due to various reasons described below. That is, in forming the trap layer on the gas sensor element body, a trap layer forming slurry is coated on a surface of the gas sensor element body in part thereof, after which a coated layer is baked. Here, aluminum ions are added to the gas sensor element body as a viscosity stabilizing agent.

When the trap layer forming slurry is coated on the surface of the gas sensor element body, the aluminum ions, remaining in the trap layer forming slurry, penetrate the diffusion resistance layer located beneath a coated layer. The resulting aluminum ions in the diffusion resistance layer remain as alumina on a stage where the trap layer has been baked. This allows the diffusion resistance layer to have increased resistance, resulting in a drop in the sensor output.

Thereafter, the gas sensor is heated in use, causing alumina components remaining in the trap layer to coagulate. This causes clearances to be widened again in the diffusion resistance layer, thereby providing improvement in the sensor output. Thus, it is conceived that the sensor output fluctuates on stages before the gas sensor is used (that is, immediately after the gas sensor has been manufactured) and after the gas sensor has been actually used.

As set forth above, it is considered that increased fluctuation occurs in the sensor output in the presence of a large amount of aluminum ions contained in the trap layer forming slurry.

### SUMMARY OF THE INVENTION

The present has been completed with a view to addressing the above issues and has an object to provide a gas sensor element and related manufacturing method that enable to provide a sensor output in minimized fluctuation.

To achieve the above object, a first aspect of the present invention provides a method of manufacturing a gas sensor element, the method comprising the steps of preparing a gas sensor element body including a solid electrolyte body having oxygen ion conductivity, a measuring-gas-side electrode formed on one surface of the solid electrolyte body, a reference-gas-side electrode formed on the other surface of the solid electrolyte body, a diffusion resistance layer formed on the one surface of the solid electrolyte body so as to surround the measuring-gas-side electrode and available to permeate measuring gas to the measuring-gas-side electrode, and forming a trap layer on at least an outer sidewall of the diffusion resistance layer. The trap layer forming step comprises the steps of coating a trap layer forming slurry, having an aluminum ion content equal to or less than 1.2 wt %, on at least the outer sidewall of the diffusion resistance layer to form a coated layer, and baking the coated layer to form the trap layer on at least the outer sidewall of the diffusion resistance layer.

With the manufacturing method of the gas sensor element, the trap layer forming slurry has the aluminum ion content selected to be equal to or less than 1.2 wt %. This enables the suppression of the amount of aluminum ions penetrating the diffusion resistance layer disposed in the sensor element body in an area beneath the trap layer. That is, this prevents a drop in the sensor output resulting from the aluminum ions penetrating the diffusion resistance layer during a phase in which the trap layer is formed. In addition, this prevents a rise in the sensor output resulting from coagulation of the aluminum ions occurring during operation of the gas sensor element in subsequent usage.

Thus, fluctuation in sensor output of the gas sensor element can be suppressed in a highly reliable manner.

As set forth above, according to the present invention, a method of manufacturing a gas sensor element can be provided which is effective to minimize fluctuation in sensor output.

A second aspect of the present invention provides a method of manufacturing a gas sensor element, the method comprising the steps of preparing a gas sensor element body including a solid electrolyte body having oxygen ion conductivity, a measuring-gas-side electrode formed on one surface of the solid electrolyte body, a reference-gas-side electrode formed on the other surface of the solid electrolyte body, a diffusion resistance layer formed on the one surface of the solid electrolyte body so as to surround the measuring-gas-side electrode and available to permeate measuring gas to the measuring-gas-side electrode, and coating a trap layer forming slurry, containing porous alumina ceramic particles having an aluminum ion content equal to or less than 1.2 wt %, on at least the outer sidewall of the diffusion resistance layer to form a coated layer. The coated layer is baked to form the trap layer on at least the outer sidewall of the diffusion resistance layer. A reference gas chamber forming layer, having a reference gas chamber facing the reference-gas-side electrode, is stacked on the gas sensor element body.

With such a manufacturing method, the aluminum ion content of the trap layer forming slurry is selected to be equal to or less than 1.2 wt %. This enables the minimization of the amount of aluminum ions penetrating the diffusion resistance layer disposed in the sensor element body in an area beneath the trap layer. That is, the aluminum ions can be prevented from penetrating the diffusion resistance layer during the formation of the trap layer, thereby minimizing the occurrence of sensor output fluctuation. In addition, the gas sensor element can prevent an increase in the sensor output caused by the coagulation of the aluminum ions during operation of the gas sensor element in subsequent usage.

Thus, fluctuation in sensor output of the gas sensor element can be suppressed in a highly reliable manner.

A third aspect of the present invention provides a gas sensor element comprising a solid electrolyte body having oxygen ion conductivity, a measuring-gas-side electrode formed on one surface of the solid electrolyte body, and a reference-gas-side electrode formed on the other surface of the solid electrolyte body. A diffusion resistance layer is formed on the one surface of the solid electrolyte body so as to surround the measuring-gas-side electrode and available to permeate measuring gas to the measuring-gas-side electrode. A trap layer is formed on an outer sidewall of the diffusion resistance layer. The gas sensor element is subjected to an endurance test conducted under an atmosphere at a temperature of 950° C. for 100 hours, the gas sensor element has a sensor output deviation rate less than 5%. The sensor output deviation rate takes a value obtained by the relationship expressed by (B−A)/B (%) where “A” represents a sensor output on a stage before the endurance test and “B” represents a sensor output on a stage after the endurance test.

With such a structure of the present embodiment, the gas sensor element has the sensor output deviation rate less than 5% on stages before and after the endurance test. Therefore, in normal usage of the gas sensor, the gas sensor element can provide outputs at a minimized deviation rate, enabling a specified gas concentration to be accurately detected. That is, the gas sensor element can provide the sensor outputs on a given specified gas concentration in less fluctuation. Thus, the specified gas concentration can be precisely detected on the basis of the sensor element of the gas sensor element.

As set forth above, according to the present invention, a gas sensor element can be provided which can minimize fluctuation in sensor output.

A fourth aspect of the present invention provides a gas sensor element comprising a solid electrolyte body having oxygen ion conductivity, a measuring-gas-side electrode formed on one surface of the solid electrolyte body, a reference-gas-side electrode formed on the other surface of the solid electrolyte body, a diffusion resistance layer formed on the one surface of the solid electrolyte body so as to surround the measuring-gas-side electrode and available to permeate measuring gas to the measuring-gas-side electrode, and a trap layer formed on an outer sidewall of the diffusion resistance layer using a trap layer forming slurry composed of porous alumina ceramic particles containing an aluminum ion content equal to or less than 1.2 wt %. The gas sensor element has a sensor output deviation rate less than 5%. The sensor output deviation rate takes a value obtained by the relationship expressed by (B−A)/B (%) where “A” represents a sensor output on a stage before the endurance test and “B” represents a sensor output on a stage after the endurance test.

With such a structure of the present embodiment, the gas sensor element provides the sensor output at a deviation rate less than 5% on stages before and after the endurance test. Therefore, the gas sensor element can provide sensor outputs with a minimized deviation rate in normal usage of the gas sensor, enabling a specified gas concentration to be accurately detected. That is, the gas sensor element can provide the sensor outputs on a given specified gas concentration in less fluctuation. Thus, the specified gas concentration can be precisely detected on the basis of the sensor element of the gas sensor element.

### BRIEF DESCRIPTION OF THE DRAWINGS

FIG. 1 is a cross sectional view showing a gas sensor element of a first embodiment according to the present invention with a diffusion resistance layer formed with a trap layer.

FIG. 2 is a basic sequence of steps of manufacturing the gas sensor element shown in FIG. 1.

FIG. 3 is a graph showing fluctuation in sensor output produced by the gas sensor element shown in FIG. 1.

FIG. 4 is a graph showing the relationship between an aluminum ion content of a trap layer forming slurry and a sensor output of a gas sensor element manufactured in Example.

FIG. 5 is a cross sectional view showing a gas sensor element of a second embodiment according to the present invention with a diffusion resistance layer formed with a trap layer.

### DETAILED DESCRIPTION OF THE PREFERRED EMBODIMENTS

Now, gas sensor elements of various embodiments and related manufacturing method according to the present invention are described below in detail with reference to the accompanying drawings. However, the present invention is construed not to be limited to such embodiments described below and technical concepts of the present invention may be implemented in combination with other known technologies or the other technology having functions equivalent to such known technologies.

In the following description, like reference characters designate like or corresponding parts throughout the several views. Also in the following description, description on the same component parts of one embodiment as those of another embodiment is omitted, but it will be appreciated that like reference numerals designate the same component parts throughout the drawings.

### First Embodiment

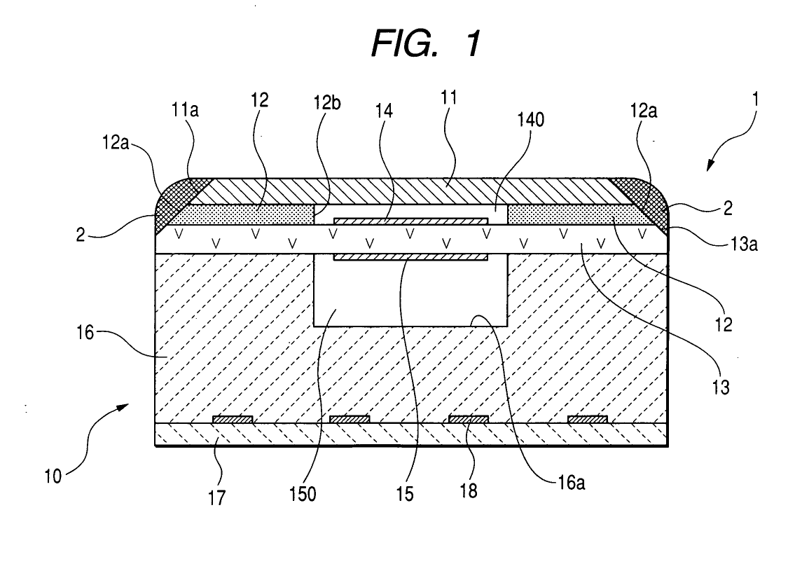

Now, a gas sensor element of a first embodiment according to the present invention is described below in detail with reference to FIGS. 1 to 4.

As shown in FIG. 1, the gas sensor element 1 of the present embodiment comprises a plate-like solid electrolyte body 13, composed of zirconium having oxygen ion conductivity, which has one surface carrying thereon a measuring-gas-side electrode 14 and the other surface carrying thereon a reference-gas-side electrode 15 formed in an area in opposition to the measuring-gas-side electrode 14.

The gas sensor 1 further comprises a flat diffusion resistance layer 12, made of porous material containing at least one of alumina particles and zirconium particles, which is formed on one surface of the solid electrolyte body 13 in an area around the measuring-gas-side electrode 14 and available to permeate targeted measuring gas to be detected with the measuring-gas-side electrode 14, and a trap layer 2 formed on a slanted outer sidewall 12a of the diffusion resistance layer 12.

More particularly, the gas sensor element 1 of the present embodiment plays a role as a stack type A/F sensor element formed in a stack structure described below in detail.

That is, as shown in FIG. 1, the solid electrolyte body 13, made of zirconium having oxygen ion conductivity, has the one surface formed with the measuring-gas-side electrode 14, made of platinum, and the other surface formed with reference-gas-side electrode 15 made of platinum.

A plate-like reference gas chamber forming layer 16, made of alumina ceramic particles, which is dense in structure and hard to permeate gas, is stacked on the other surface of the solid electrolyte body 13. A recessed section 16a, acting as a reference gas chamber 150, is formed between the solid electrolyte body 13 and the reference gas chamber forming layer 16 and supplied with atmospheric air as reference gas. With such a structure, the reference-gas-side electrode 15 faces the reference gas chamber 150.

Further, a heater substrate 17 is stacked on the reference gas chamber forming layer 16 on a bottom surface thereof. The heater substrate 17 has one surface carrying thereon a plurality of electrical heating elements 18, placed in the one surface at horizontally spaced positions so as to face the reference gas chamber forming layer 16, which are electrically conductive and energized to develop heat. The heating elements 18 are warmed upon conducting to heat the solid electrolyte body 13.

Furthermore, a plate-like shielding layer 11, made of alumina and having a dense structure not to permeate gas, is stacked on the diffusion resistance layer 12 so as to face the measuring-gas-side electrode 14 formed on the solid electrolyte body 13. The diffusion resistance layer 12 is sandwiched between the shielding layer 11 and the solid electrolyte body 13 and formed with an opening portion 12b. The opening portion 12b of the diffusion resistance layer 12 defines a measuring gas chamber 140 under a status covered with the shielding layer 11, the opening portion 12b of the diffusion resistance layer 12 and the solid electrolyte body 13 for introducing measuring gas to be detected with the measuring-gas-side electrode 14.

Moreover, as set forth above, the outer sidewall 12a of the diffusion resistance layer 12 carries thereon the trap layer 2, made of metal oxide particles such as porous alumina ceramic particles containing catalytic components such as Pt or Rh, which has an end portion covering a slanted outer sidewall 11a of the shielding layer 11. The trap layer 2 has the other end portion that covers a slanted outer sidewall 13a of the solid electrolyte body 13. The slanted outer sidewalls 11a, 12a, 13a are aligned on the same plane as shown in FIG. 1.

More particularly, the trap layer 2 may be composed of alumina ceramic particles and have a porosity rate of 40 to 70% with an average pore size diameter falling in a value ranging from 0.1 to 10 μm. This allows the metal oxide particles to have adequately large surface areas for supporting the catalytic components, while enabling the trap layer 2 to be available to permeate measuring gases in an adequate volume.

While the gas sensor element 1 of the present embodiment is shown to have a structure including the trap layer 2 formed on the outer sidewalls 11a, 12a, 13a of the shielding layer 11, the diffusion resistance layer 12 and the solid electrolyte body 13, it will be appreciated that the trap layer 2 may be suffice to be formed on at least the outer sidewall 12a of the diffusion resistance layer 12. In an alternative, the trap layer 2 may be formed on an entire circumferential periphery of a detecting section of the gas sensor element 1.

### EXAMPLE 1

The gas sensor element 1 of the present embodiment was manufactured in Example 1. In this Example 1, the trap layer 2 was formed on the outer sidewall 12a of the diffusion resistance layer 12 upon forming a coated layer on the sensor element body 10 using a trap layer forming slurry and baking the coated layer to form the trap layer on the sensor element body.

That is, in applying the coated layer of the trap layer forming slurry, the trap layer forming slurry, having aluminum ion content of a value equal to or less than 1.2 wt % (500 ppm), was used and coated on at least the outer sidewall 12a of the diffusion resistance layer 12 of the gas sensor element 1 to form a coated layer.

Further, in baking the coated layer, the coated layer of the trap layer forming slurry applied to the senor element body 10 was subjected to a baking process, thereby forming the trap layer 2.

In addition, the aluminum ion content of the trap layer forming slurry was selected to lie in a value more preferably equal to or less than 0.48 wt % (200 ppm). Also, the trap layer forming slurry was formed of alumina sol.

During the coated layer forming step, the trap layer forming slurry may be formed on the sensor element body 10 using various methods such as, for instance, dipping, coating with a dispenser or the like.

Further, tests were conducted on the resulting gas sensor element 1, which was found to have properties described below. That is, the gas sensor element 1 was subjected to an endurance test under an atmospheric environment at 950° C. for 100 hours and the resulting gas sensor element 1 had a sensor output deviation rate less than 5% on stages before and after the endurance test.

In addition, more preferably, the sensor output deviation rate was selected to be less than 2%. As used herein, the term “sensor output deviation rate” refers to a value calculated using the relationship expressed as (B−A)/B (%) where “A” represents a sensor output before the endurance test and “B” represents a sensor output after the endurance test.

Further, with the gas sensor element 1 of the present embodiment used as an A/F sensor element, the sensor output represents an electric current value that flows across the measuring-gas-side electrode 14 and the reference-gas-side electrode 15. Also, with the gas sensor element 1 of the present embodiment used as, for instance, an O₂ sensor element, the sensor output represents a value of an electromotive force occurring between both of these electrodes.

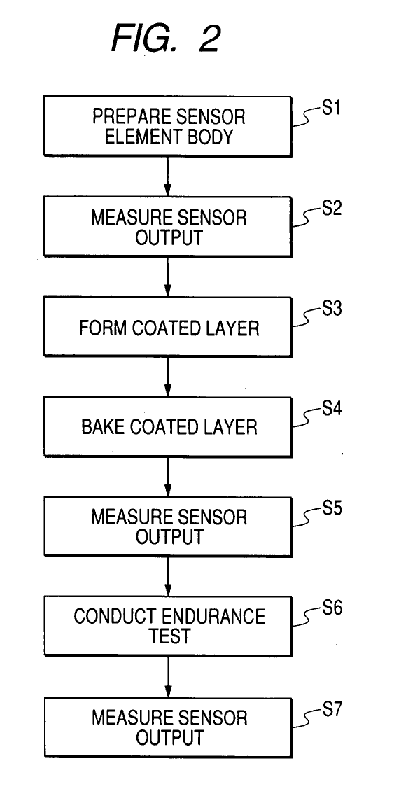

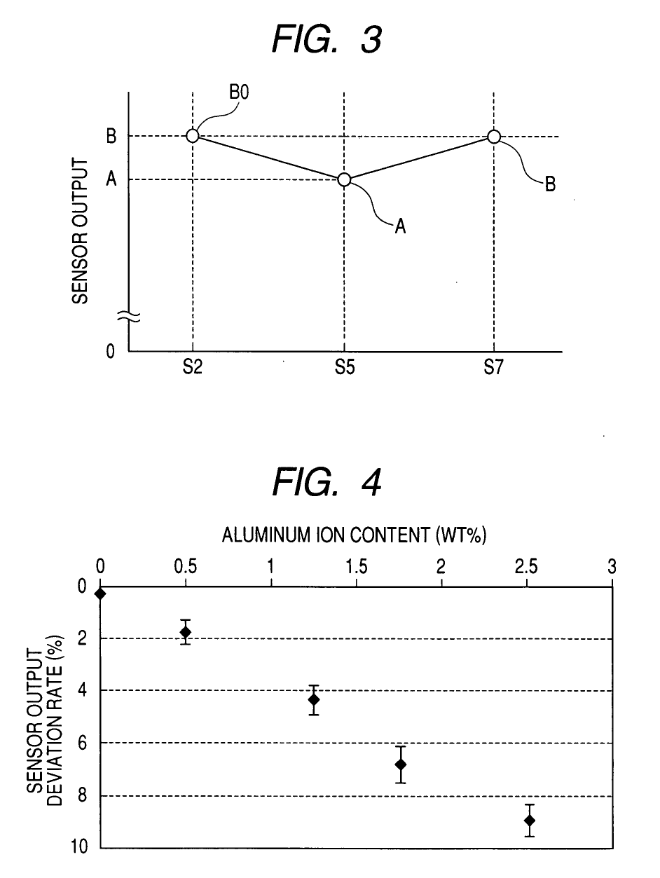

Hereunder, description is made of a method of manufacturing the gas sensor element of the present embodiment, endurance tests on the resulting gas sensor element and measurements of sensor outputs with reference to FIGS. 2 and 3.

As set forth above, first in step S1, the sensor element body 10 is prepared upon stacking the solid electrolyte body 13, formed with the measuring-gas-side electrode 14 and the reference-gas-side electrode 15, the diffusion resistance layer 12, the shielding layer 11, the reference gas chamber forming layer 16, and the heater substrate 17 formed with the heater elements 18.

In next step S2, sensor output properties of the resulting sensor element body 10 are measured. That is, exhaust gases having an oxygen (O₂) concentration of about 4% are introduced into the measuring gas chamber 140 as measuring gas via the trap layer 2 and the diffusion resistance layer 12. Exhaust gases have an air fuel ratio (A/F) in a range of 18. In addition, the sensor element body 10 is heated at a temperature of 800° C. Under such a state, a given voltage is applied across the measuring-gas-side electrode 14 and the reference-gas-side electrode 15 of the sensor element body 10 and the resulting electric current is measured.

The measurement of such electric current results in a consequence of obtaining a sensor output in the form of an electric current value. The resulting sensor output value (electric current value) is plotted as B0 on a graph shown in FIG. 3.

In succeeding step S3, the sensor element body 10 is returned to a normal temperature, after which coated layer forming step was conducted. Then, in step S4, baking step is conducted to form the trap layer on the sensor element body 10. During the baking step for forming the trap layer, the sensor element body 10 having the coated layer of the trap layer forming slurry is placed in a furnace maintained at a temperature of 900° C. for one hour. During such a baking step, the trap layer 2 is baked, thereby obtaining the gas sensor element 1.

In subsequent step S5, a sensor output characteristic of the resulting gas sensor element 1 is measured in the same method as that carried out in step S2. The resulting sensor output is plotted as an electric current value A in the graph shown in FIG. 3.

In next step S6, the resulting gas sensor element 1 is subjected to an endurance test. That is, the resulting gas sensor element 1 is placed under atmospheric environment at a temperature of 950° C. for 100 hours.

Then, in step S7, a sensor output characteristic of the resulting gas sensor element 1 is measured in the same method as those carried out in steps S2 and S5. The resulting sensor output is plotted as an electric current value B in the graph shown in FIG. 3.

Thus, the sensor output characteristic of the resulting gas sensor has fluctuation plotted in the graph of FIG. 3. In FIG. 3, references S2, S5 and S7 plotted on a horizontal axis of the graph shown in FIG. 3 represent steps S2, S5 and S7 at which the sensor outputs of the gas sensor element 1 are measured. In addition, a longitudinal axis of the graph shown in FIG. 3 represents the sensor output of the resulting gas sensor element 1.

As will be apparent from the graph shown in FIG. 3, the sensor element body 10, remaining under a status (in step S2) with no formation of the trap layer 2, has the sensor output B0. On the contrary, with the sensor element body 10 formed with the trap layer 2 on a stage before the endurance test being conducted (in step S5), the sensor output A is lowered than the sensor output B0. This seems to be derived from the fact that aluminum ions, contained in the trap layer forming slurry, entered the diffusion resistance layer 12 and remained therein with the occurrence of an increase in resistance of the diffusion resistance layer 12.

Further, the sensor output B of the resulting gas sensor element 1 on a stage after completion of the endurance test (in step S7) is higher than the sensor output A appearing on a stage before the endurance test has been conducted (in step S5). This is considered from the fact that the aluminum ions entered the diffusion resistance layer 12 have agglutinated due to heat developed when the endurance test has been conducted with the occurrence of a decrease in resistance of the diffusion resistance layer 12.

Furthermore, the sensor output B0 of the sensor element body 10 under the status (in step S2) before the trap layer 2 has been formed is nearly equal to the sensor output B of the sensor element body 10 under the status (in step S7) after the endurance test has been conducted. This seems to be derived from the fact that the aluminum ions entered the diffusion resistance layer 12 have adequately agglutinated upon completion of the endurance test with no adverse affect of the aluminum ions acting on resistance of the diffusion resistance layer 12.

With the gas sensor element 1 of the present embodiment, thus, the sensor outputs A and B fall in the relationship expressed as (B−A)/B≦0.05 and, more preferably, (B−A)/B≦0.02.

Now, the operation and advantageous effects of the gas sensor element 1 of the present embodiment are described below in detail.

With the gas sensor element 1 of the present embodiment, the trap layer forming slurry is selected to contain the aluminum ion content equal to or less than 1.2 wt %. This restricts the amount of aluminum ions penetrating into the diffusion resistance layer 12 formed in an area beneath the trap layer 2 of the resulting gas sensor element 1. This prevents the occurrence of a decrease in a sensor output resulting from the aluminum ions penetrating the diffusion resistance layer 12 during a process in which the trap layer 2 is formed. In addition, this prevents a rise in the sensor output of the gas sensor element 1 caused by the aggregation of the aluminum ions after subsequent use thereof.

Therefore, variation in sensor output of the gas sensor element 1 can be minimized.

Further, the trap layer forming slurry is selected to have an aluminum ion content equal to or less than 0.48 wt % and a further decrease in adverse affect of the aluminum ions acting on the diffusion resistance layer 12 of the gas sensor element 1. This results in capability of obtaining the gas sensor element 1 with a further reduction in variation of the sensor output.

Furthermore, since the trap layer forming slurry is composed of material containing alumina sol, the trap layer forming slurry is able to easily have stabilized viscosity making it easy to form the trap layer 2 in a stable fashion. That is, with the present invention, since the trap layer forming slurry has a low aluminum ion content, a risk occurs for the trap layer forming slurry to have instable viscosity. To avoid such a risk, the alumina sol is added to the trap layer forming slurry, enabling a slurry viscosity to be stabilized.

Moreover, with the gas sensor element 1 of the present embodiment subjected to the endurance test conducted at a temperature of 950° C. for 100 hours, the gas sensor element 1 has a sensor output deviation rate falling in a value less than 5% in phases before and after the endurance test. Therefore, no remarkable fluctuation takes place in the output of the gas sensor element 1 under normal usage. Thus, the gas sensor element 1 can accurately detect a specified gas concentration (oxygen concentration) in measuring gases in a highly reliable manner. That is, the gas sensor element 1 is able to have minimized fluctuation in a sensor output detected for a given specified gas concentration (oxygen concentration), enabling a specified gas concentration (oxygen concentration) to be precisely detected from the sensor output of the gas sensor element 1.

Moreover, the presence of the sensor output deviation rate selected to be less than 2% enables a further decrease in fluctuation in outputs of the gas sensor element 1. This results in capability for the gas sensor element 1 to further accurately detect a specified gas concentration. Accordingly, this makes it possible to have the gas sensor element 1 providing the sensor output in further minimized fluctuation.

As set forth above, the present embodiment according to the present invention is possible to provide a gas sensor element and related manufacturing method that can minimize fluctuation in sensor outputs.

### EXAMPLE 2

In this Example 2, gas sensor elements 1 were prepared to study sensor output deviation rates of the gas sensor elements 1 on stages before and after endurance tests in term of the relationship with aluminum ion contents of trap layer forming slurries used for trap layers of the gas sensor elements 1.

That is, five kinds of trap layer forming slurries were prepared containing aluminum ion contents ranging from 0 to 2.4 wt %. Then, five kinds of gas sensor elements 1 were prepared using these trap layer forming slurries. These gas sensor elements 1 were manufactured in the same manufacturing method of the gas sensor element 1 of Example 1 except for the aluminum ion contents of trap layer forming slurries being altered in value. In addition, the trap layer forming slurry with an aluminum ion contents of 2.4 wt % corresponds to that employed in the related art method of manufacturing the gas sensor element.

Then, ten gas sensor elements were manufactured as test pieces using the respective trap layer forming slurries. Sensor outputs of these test pieces on stages before and after endurance tests were measured in the same method as that in which the sensor outputs were measured in Example 1. Average values, maximal values and minimal values of sensor outputs in respective levels are plotted in a graph shown in FIG. 4.

As will be apparent from the graph of FIG. 4, the sensor output deviation rate varies such that the greater the aluminum ion content, the higher will be the sensor output deviation rate. With the trap layer forming slurry having the sensor output deviation rate less than 1.2 wt %, the sensor output deviation rate of the gas sensor element can be suppressed to a level less than 5%. In addition, with the trap layer forming slurry having the aluminum ion content less than 0.48 wt %, the sensor output deviation rate of the gas sensor element can be suppressed to a level less than 2%.

### Second Embodiment

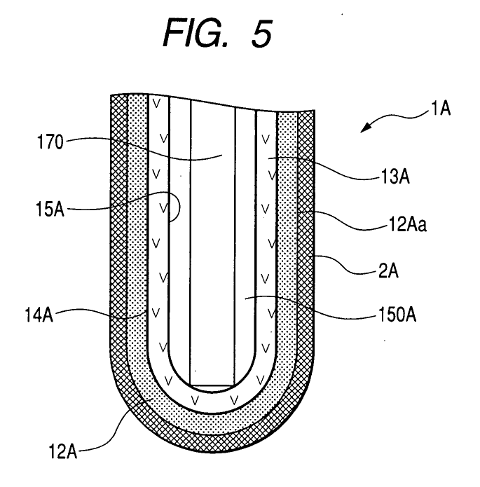

A cup-shaped gas sensor element of a second embodiment according to the present invention is described with reference to FIG. 5.

With a structure shown in FIG. 5, the cup-shaped gas sensor element 1A includes a bottomed, cylindrical solid electrolyte body 13A, a reference-gas-side electrode 15A formed on an inner cylindrical wall of the solid electrolyte body 13A, and a measuring-gas-side electrode 14A formed on an outer cylindrical wall of the solid electrolyte body 13A. In addition, the solid electrolyte body 13B is formed with a cylindrical reference gas space 150A to which a heater 170 is inserted and placed in a fixed position.

Further, a diffusion resistance layer 12A is formed on an entire surface of the outer peripheral surface of the solid electrolyte body 13A and a trap layer 2A is formed on an entire surface of an outer peripheral surface 12Aa of the diffusion resistance layer 12A.

The trap layer 2A is formed on the outer circumferential periphery 12Aa of the diffusion resistance layer 12A using the same trap layer forming slurry as that used in the gas sensor element of the first embodiment. Further, the gas sensor element 1A of the second embodiment provides a sensor output deviation rate on stages before and after an endurance test that is minimized to the same low level as that achieved in the gas sensor element 1 of the first embodiment.

The gas sensor element 1A of the present embodiment is similar in other structure to that of the gas sensor element 1 of the first embodiment.

Advantageous Effects

The gas sensor element of the present embodiment may be applied to, for instance, an A/F sensor, an O₂ sensor and NOx sensor.

Further, the gas sensor element of the present embodiment may be formed in a stack type gas sensor element including a plate-like solid electrolyte body or in a cup type gas sensor element including a bottomed cylindrical solid electrolyte body as mentioned above.

Under a circumstance where with the manufacturing method of the first aspect of the present invention, the trap layer forming slurry has the aluminum ion content greater than 1.2 wt %, a difficulty is encountered in adequately suppressing fluctuation in sensor output resulting from the coagulation of the aluminum ions. This results in a difficulty of obtaining a gas sensor element with high precision.

Further, the aluminum ion content of the trap layer forming slurry may be preferably selected to be less than 0.48 wt %.

With such a selected aluminum ion content, adverse affect of the aluminum ions can be further minimized, enabling the provision of a gas sensor element with further minimized fluctuation in sensor output.

Furthermore, the aluminum ion content of the trap layer forming slurry may be zeroed, that is, at a value of 0 wt %. In other words, the trap layer forming slurry may be sufficed not to contain aluminum ions.

Moreover, the trap layer forming slurry may preferably contain alumina sol.

With such a trap layer forming slurry, the trap layer forming slurry can have a stabilized viscosity, making it easy to form a trap layer on the gas sensor element body in a stable fashion. That is, with the present invention, the aluminum ion content can be lowered in the trap layer forming slurry, causing a risk to occur is wherein the trap layer forming slurry has an unstable viscosity. The presence of the alumina sol added to the trap layer forming slurry enables a slurry viscosity to be stabilized in a reliable manner.

With the gas sensor element of the third aspect of the present invention, the sensor output can be generated in the form of an electric current value flowing between the measuring-gas-side electrode an the reference-gas-side electrode of the gas sensor element or an electromotive force value occurring across both of these electrodes.

Further, in a case where the sensor output deviation rate exceeds a value of 5%, a difficulty is encountered in adequately minimizing fluctuation in sensor output in normal usage. As a result, it becomes hard to minimize fluctuation in sensor output for a given specified gas concentration. Thus, there is a fear with the occurrence of a difficulty of accurately detecting the specified gas concentration from the sensor output of the gas sensor element.

Further, the sensor output deviation rate may be preferably less than a value of 2%.

Such a sensor output deviation rate enables a further reduction in fluctuation of outputs of the gas sensor element in normal usage, making possible for a specified gas concentration to be accurately detected. Accordingly, it becomes possible to provide a gas sensor element that provides sensor outputs in further minimized fluctuation.

While the specific embodiment of the present invention has been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. A method of manufacturing a gas sensor element, the method comprising the steps of:
preparing a gas sensor element body including a solid electrolyte body having oxygen ion conductivity, a measuring-gas-side electrode formed on one surface of the solid electrolyte body, a reference-gas-side electrode formed on the other surface of the solid electrolyte body, a diffusion resistance layer formed on the one surface of the solid electrolyte body so as to surround the measuring-gas-side electrode and available to permeate measuring gas to the measuring-gas-side electrode; and
forming a trap layer on at least an outer sidewall of the diffusion resistance layer;
wherein the trap layer forming step comprises:
coating a trap layer forming slurry, having an aluminum ion content equal to or less than 1.2 wt %, on at least the outer sidewall of the diffusion resistance layer to is form a coated layer; and
baking the coated layer to form the trap layer on at least the outer sidewall of the diffusion resistance layer.

2. The method of manufacturing the gas sensor element according to claim 1, wherein:
the trap layer forming slurry has the aluminum ion content equal to or less than 0.48 wt %.

3. The method of manufacturing the gas sensor element according to claim 1, wherein:
the trap layer forming slurry includes an aluminum sol.

4. A method of manufacturing a gas sensor element, the method comprising the steps of:
preparing a gas sensor element body including a solid electrolyte body having oxygen ion conductivity, a measuring-gas-side electrode formed on one surface of the solid electrolyte body, a reference-gas-side electrode formed on the other surface of the solid electrolyte body, a diffusion resistance layer formed on the one surface of the solid electrolyte body so as to surround the measuring-gas-side electrode and available to permeate measuring gas to the measuring-gas-side electrode;
coating a trap layer forming slurry, containing porous alumina ceramic particles having an aluminum ion content equal to or less than 1.2 wt %, on at least the outer sidewall of the diffusion resistance layer to form a coated layer;
baking the coated layer to form the trap layer on at least the outer sidewall of the diffusion resistance layer; and
stacking a reference gas chamber forming layer, having a reference gas chamber facing the reference-gas-side electrode, on the gas sensor element body.

5. The method of manufacturing the gas sensor element according to claim 4, wherein:
the trap layer forming slurry has the aluminum ion content equal to or less than 0.48 wt %.

6. The method of manufacturing the gas sensor element according to claim 4, wherein:
the trap layer forming slurry includes an aluminum sol.

7. A gas sensor element comprising:
a solid electrolyte body having oxygen ion conductivity;
a measuring-gas-side electrode formed on one surface of the solid electrolyte body;
a reference-gas-side electrode formed on the other surface of the solid electrolyte body;
a diffusion resistance layer formed on the one surface of the solid electrolyte body so as to surround the measuring-gas-side electrode and available to permeate measuring gas to the measuring-gas-side electrode; and
a trap layer formed on an outer sidewall of the diffusion resistance layer;
wherein with the gas sensor element subjected to an endurance test conducted under an atmosphere at a temperature of 950° C. for 100 hours, the gas sensor element has a sensor output deviation rate less than 5%; and
wherein the sensor output deviation rate takes a value obtained by the relationship expressed by (B−A)/B (%) where A represents a sensor output on a stage before the endurance test and B represents a sensor output on a stage after the endurance test.

8. The gas sensor element according to claim 7, wherein:
the sensor output deviation rate remains in a value less than 2%.

9. A gas sensor element comprising:
a solid electrolyte body having oxygen ion conductivity;
a measuring-gas-side electrode formed on one surface of the solid electrolyte body;
a reference-gas-side electrode formed on the other surface of the solid electrolyte body;
a diffusion resistance layer formed on the one surface of the solid electrolyte body so as to surround the measuring-gas-side electrode and available to permeate measuring gas to the measuring-gas-side electrode; and
a trap layer formed on an outer sidewall of the diffusion resistance layer using a trap layer forming slurry composed of porous alumina ceramic particles containing an aluminum ion content equal to or less than 1.2 wt %;
wherein the gas sensor element has a sensor output deviation rate less than 5%; and
wherein the sensor output deviation rate takes a value obtained by the relationship expressed by (B-A)/B (%) where A represents a sensor output on a stage before the endurance test and B represents a sensor output on a stage after the endurance test.

10. The gas sensor element according to claim 9, wherein:
the sensor output deviation rate remains in a value less than 2%.

11. The gas sensor element according to claim 9, wherein:
the solid electrolyte body and the diffusion resistance layer are flat in structure to form a stack type sensor element body.

12. The gas sensor element according to claim 9, wherein:
the solid electrolyte body includes a bottomed, cylindrical solid electrolyte body;
the reference-gas-side electrode is formed on an inner cylindrical wall of the cylindrical solid electrolyte body;
the measuring-gas-side electrode is formed on an outer cylindrical wall of the cylindrical solid electrolyte body; and
the diffusion resistance layer is formed on the measuring-gas-side electrode.
